(19) United States
(12) Patent Application Publication
(10) Pub. No.: US 2002/0162592 A1
(43) Pub. Date: Nov. 7, 2002

(54) Solenoid operated, three way, normally closed, high flow, pressure compensated proportional pilot valve

(76) Inventor: Charles J. Bowden, Battle Creek, MI (US)

Correspondence Address: FLYNN, THIEL, BOUTELL & TANIS, P.C., 2026 Rambling Road, Kalamazoo, MI, 49008-1699, US

(21) Appl. No.: 09/846,168

(22) Filed: May 1, 2001

(51) Int. Cl. F15B 13/043

(52) U.S. Cl. 137/625.64

(57) ABSTRACT

A pilot valve having a sleeve with a central hole therethrough and a first undercut region in an exterior surface thereof which includes a further passageway. A spool is reciprocally mounted in the further passageway for movement between first and second positions. A first end of the spool and a second undercut region thereon has a radially outwardly extending flange larger in diameter than a diameter of the central hole. A spring is provided for continually urging the flange toward a first position thereof in engagement with a first end of the sleeve to effect a closing off of the communication between the second undercut region and the passageway. A second end of the spool defines a nozzle orifice and opposes an end of the armature member configured to selectively move toward and away from the nozzle orifice to control a level of pressure at the control port.

### FIELD OF THE INVENTION

This invention relates to a pilot valve, namely, a generally small, low flow valve that is used to control a larger component, such as a spool or piston and, more particularly, to an electro-mechanically operated, three way, normally closed, high flow, pressure compensated proportional pilot valve.

### BACKGROUND OF THE INVENTION

A prior art frictionless solenoid operable in association with a liquid controlling valve is illustrated in FIG. 1. The illustration in FIG. 1 represents the closest prior art known to the inventor.

The solenoid portion 10 of the solenoid operated valve 11 consists of an armature 12 suspended in the center of an annular coil 13 by a pair of flat substantially linear springs 14 and 16 attached to the armature 12 at one end and attached to the solenoid pole pieces 17 and 18 at the other end to prevent radial movements. The pole pieces 17 and 18 are oriented at the ends of the annular coil 13 and are connected together by a metal tube 19 made of a magnetic material which is oriented around the outside of the annular coil 13. The tube serves the purpose of completing the flux carrying magnetic circuit.

The pole piece 17 oriented to the left of the annular coil has a large opening 21 in it and is adapted to receive therein the armature 12. The radial space between the outside diameter of the armature 12 and the inside diameter of the opening 21 serves to define a non-working air gap 22. This end of the armature also has an elongate rod 23 formed on the left axial end face of the armature and it is this rod 23 that is secured to the aforesaid spring 14. A hole in the center of the spring 14 allows the rod 23 to extend therethrough. A resilient spacer 24 is provided to space the spring 14 from the axial end face of the armature 12 and a retainer ring 26 is utilized to hold the spring 14 against the resilient spacer 24.

The opposite pole piece 18 also has a hole 27 extending therethrough. The armature has a non-magnetic rod 28 formed on the right axial end face of the armature and extends axially away therefrom into and through a hole in the spring 16 whereat it is fixedly attached to the rod 28. The two springs 14 and 16 serve to suspend the armature 12 and the two axially protruding rods 23 and 28 in the respective holes through the pole pieces 17 and 18 as well as through the central hole in the annular coil 13 so as to create a frictionless support for the armature.

In this particular prior art construction, a liquid control valve 31 is oriented at the right end of the housing 29 which houses the aforesaid armature 12 and annular coil 13. The liquid control valve 31 includes a central bore 32 therethrough having a plurality of liquid ports therein, namely, a liquid supply port 33, a control port 34 and a tank port 36. A nozzle 37 is provided in the bore 32 between the supply port 33 and the tank port 36 axially spaced from the supply port 33. The nozzle 37 has a nozzle opening 38 therein so that liquid supplied through the supply port 33 to the control port 34 is bled through the nozzle opening 38 to the tank port 36 when a button 39 fixedly secured to the rod 28 and movable therewith is spaced away from the nozzle opening 38 as illustrated in FIG. 1.

The right axial end face of the armature 12 is normally axially spaced from the left axially facing surface of the pole piece 18 when the annular coil 13 is not electrically energized. The axial space defines a working air gap 41. As a result, when the annular coil 13 is electrically energized, the armature 12 will be driven rightwardly toward the pole piece 18. In addition, the right axial end face 42 will move into close relation with the nozzle opening 38 to block liquid flow from the control port 34 to the tank port 36. As a result, pressure will build up in the control port 34 to effect an appropriate drive of a mechanism connected thereto.

Electrical energy is supplied to the annular coil 13 through an electrical connection 43.

It is, of course, possible to substitute for the button 39 and the nozzle 37 an axially reciprocal spool having lands thereon for directing fluid from the supply port 33 to the control port 34 and/or to the tank port 36. However, the land construction on such spools generally necessitates a long stroke length by the armature 12 and long, accurately controlled stroke lengths in a magnetic circuit are difficult to achieve as well as being expensive to achieve. Further, it is often necessary to accurately control the position of land to land configurations in the housing or the spool and it is difficult to achieve high flow with minimal performance variation during short strokes. In other words, long strokes are generally required in such spool environments to achieve high flow rates. It is, of course, possible to provide additional undercutting adjacent the lands, but this involves even more expense in the manufacture. The invention set forth herein successfully resolves the issue of achieving a high flow rate with a minimal stroke in a magnetically operated device.

### SUMMARY OF THE INVENTION

A pilot valve having a reciprocal armature member having a housing which includes a liquid control valve having an elongate passageway, a liquid supply port adapted to receive a supply of liquid from the supply and connected to the passageway. A control port is provided and is connected to the passageway and is adapted for connection to a load and a tank port configured for communication with the supply. A sleeve is positioned within the passageway and is sealingly connected to a wall surface thereof. The sleeve has a central hole therethrough and a first undercut region in an exterior surface thereof. The first undercut region includes a further passageway providing communication from the first undercut region to the central hole. A spool is sealingly, slidingly reciprocally mounted in the further passageway for movement between first and second positions. The spool has a length greater than a length of the sleeve and a central bore therethrough as well as a second undercut region in an exterior surface thereof communicating with the further passageway. A first end of the spool and the second undercut region has a radially outwardly extending flange larger in diameter than a diameter of the central bore. An elastically yieldable member for continually urging the radially outwardly extending flange and the spool toward a first position thereof in engagement with a first end of the sleeve to effect a closing off of the communication between the second undercut region and the passageway. A second end of the spool has an end surface encircling the central bore to define a nozzle orifice and opposing a parallel surface on an end of the armature member configured to selectively move toward and away from the nozzle orifice to control a level of pressure at the control port.

### BRIEF DESCRIPTION OF THE DRAWINGS

Other objects and purposes of this invention will be apparent to persons acquainted with apparatus of this general type upon reading the following specification and inspecting the accompanying drawings, in which:

FIG. 1 illustrates a prior art frictionless solenoid operated valve;

FIG. 2 illustrates a frictionless solenoid operated valve including the invention therein; and

FIG. 3 is a view like FIG. 2, but wherein the armature has shifted to a second position thereof.

### DETAILED DESCRIPTION

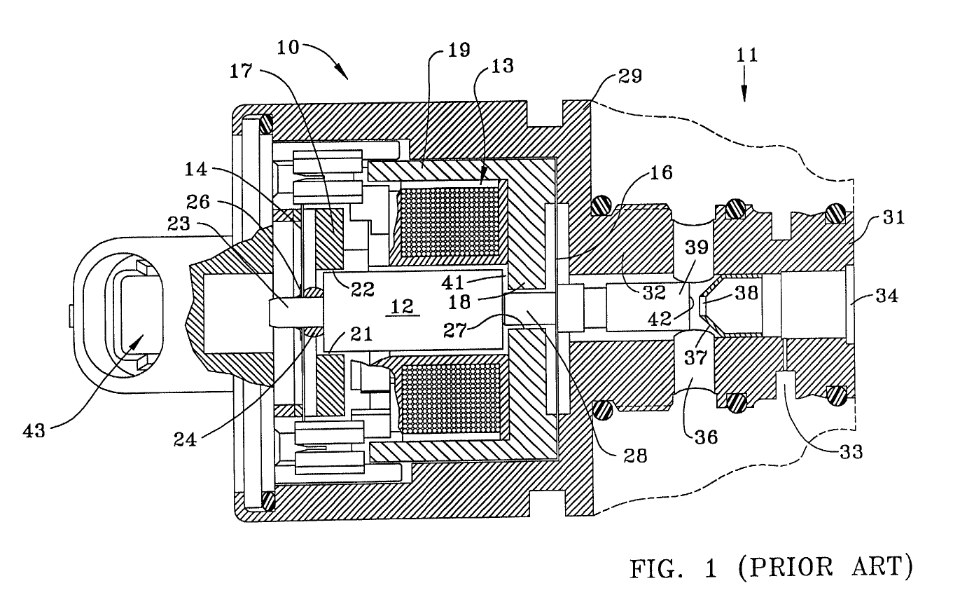

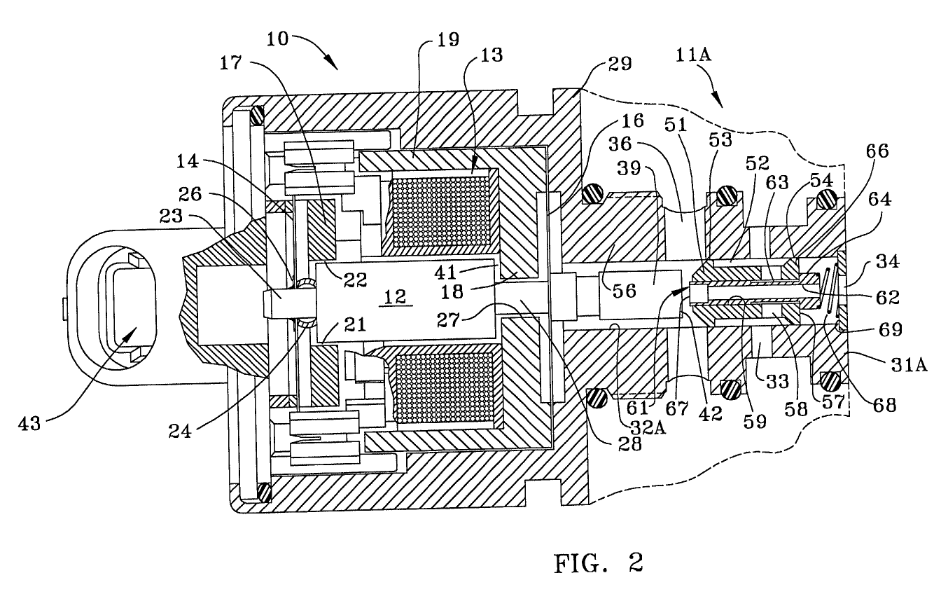

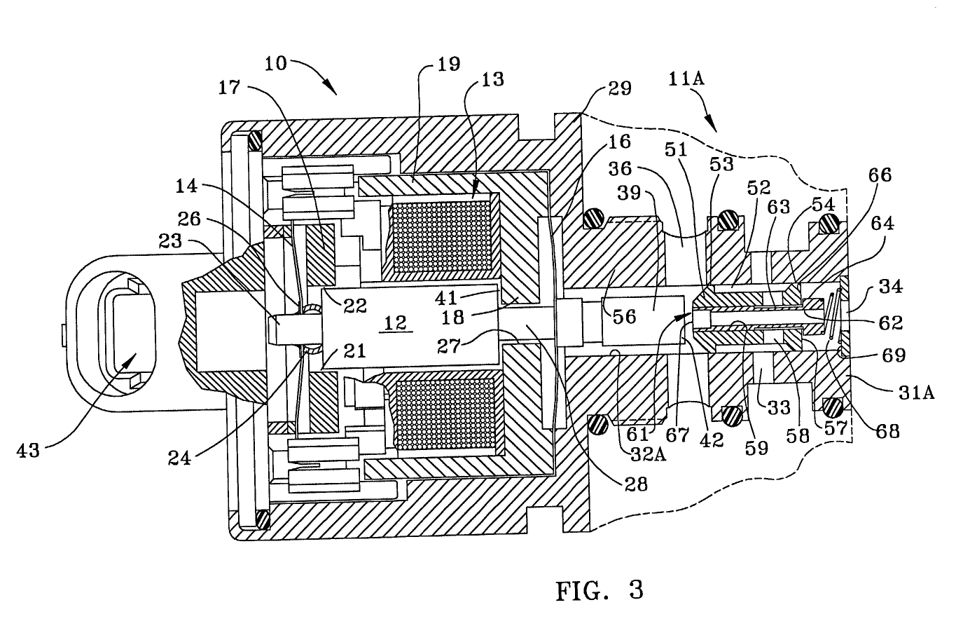

In FIGS. 2 and 3, the electro-mechanical or solenoid portion 10 of the solenoid operated valve 11A is identical to the configuration illustrated in FIG. 1. The primary difference between the structure illustrated in FIG. 1 and the structure illustrated in FIGS. 2 and 3 is the structure of the liquid control valve 31A oriented at the right end of the housing 29 which houses the aforesaid armature 12 and annular coil 13. The central bore 32A in the valve 31A is of a uniform diameter throughout its length.

A sleeve-like member 51 is provided in the central bore 32A. More specifically, the sleeve-like member 51 is generally cylindrical in configuration and has an undercut region 52 provided in the exterior surface thereof communicating with the supply port 33. Axially spaced lands 53 and 54 are oriented at the axial ends of the undercut region 52 and sealingly engage the interior facing wall 56 of the central bore 32A. In this particular embodiment, the radially outer dimension of the lands 53 and 54 are sized to the internal diameter of the central bore 32A so as to facilitate a forced fit relation between the sleeve-like member 51 and the central bore 32A holding the sleeve-like member 51 fixed in the central bore 32A. The axially facing right end surface 57 of the sleeve-like member 51 is planar and is oriented in a plane perpendicular to the longitudinal axis of the sleeve-like member 51. A plurality of passageways 58 are provided in the undercut region 52 of the sleeve-like member 51 to provide communication between the undercut region 52 and a central hole 59 through the sleeve-like member 51. In this particular embodiment, the lands 53 and 54 are oriented on opposite sides of the supply port 33.

A spool 61 is sealingly, slidingly reciprocally mounted within the central hole 59. The spool 61 includes a length that is greater than the overall length of the sleeve-like member 51. As a result, the opposite axial ends of the spool 61 project outwardly from the central hole 59 of the sleeve-like member 51. The spool 61 has a central bore 62 therethrough. An external surface of the spool 61 has an undercut region 63 therein communicating with the passageway 58. The undercut region 63 terminates at one end thereof in a radially outwardly extending flange 64 also oriented at an axial end of the spool 61. The radially outer diameter of the flange 64 is greater than the diameter of the central hole 59 in the sleeve-like member 51. The left axially facing surface 66 on the flange 64 is conformed to the axial end face 57 so that when the surface 66 engages the surface 57, fluid communication between the undercut regions 63 and the control port 34 is blocked.

The end of the spool 61 opposite the flange 64 is configured into an annular surface 67 oriented in a plane preferably perpendicular to the longitudinal axis of the spool 61 as well as in a plane parallel to the opposing surface 42 of the button 39.

An elastically yieldable member 68 in the form of a compression spring is provided between an annular surface 69 encircling the control port 34 and the radially outwardly extending flange 64 so as to continually urge the spool 61 to the position illustrated in FIG. 2, namely, wherein the surface 66 on the flange 64 is in engagement with the surface 57 on the sleeve-like member 51.

In operation, the solenoid portion 10 can be energized with an analog input signal or a pulse width modulated (PWM) input signal. For purposes of the following discussion, the description will resort to the provision of an analog input signal.

In the de-energized state (see FIG. 2), the spool is biased by the spring 68 in a direction that seals off the communication between the undercut region 63 and the control port 34 by reason of the surface to surface engagement between the surface 66 on the flange 64 and the surface 57 on the sleeve-like member 51. Since the seat diameter and the spool diameter are the same, the spool is in essence pressure balanced in the undercut area 63. The control port is connected to tank via the central bore 62 through the spool and the gap between the surface 42 on the button 39 and the end face 67 on the spool 61.

When the solenoid portion 10 is energized (see FIG. 3) to a position less than full on, the surface 42 on the button 39 is driven toward the surface 67 on the spool 61 to move the spool 61 slightly against the urging of the spring 68 to seal off or close the communication between the control port 34 and the tank port 36. The button continues moving thereby urging the spool 61 so that a spacing occurs between the surfaces 66 and 57 thereby allowing liquid flow and pressure to be communicated between the supply port 33 and the control port 34. The pressure in the control port 34 will rise until there is a sufficient load acting on the end face of the spool 61 facing the control port 34 plus the bias load of the spring 68 to equal the output load provided by the armature 12 effecting an urging of the surface 42 on the button 39 into engagement with the surface 67 on the spool 61. At this time, if the pressure in the control port 34 tries to continue increasing, the increase in load applied to the spool 61 will push it back toward the surface 42 on the button 39 thereby also reducing the opening between the supply and control and thereby restricting the flow to effect a maintaining of a relatively constant control pressure. If the pressure continues to rise, the spool 61 will continue moving shutting off the opening between the supply port 33 and the control port 34. The increased pressure will then push the surface 67 on the spool off from the button surface 42 venting fluid and pressure from the control port 34 thereby maintaining a relative constant pressure at the control port.

Also during operation, if for some reason, the pressure in the control port tries to decrease, the reduced pressure (load) on the spool 61 allows the button 39 to push the spool 61 rightwardly, increasing the communication between the supply port and the control port thereby allowing more flow and pressure into the control unit until the spool load and the solenoid load balances thereby maintaining a relative constant control pressure. As a result, increasing and/or decreasing the solenoid input signal increases and decreases the solenoid (button) load respectively and changes the control pressure correspondingly, and it maintains that pressure as described above.

When a fast response, changing from one pressure to another is to occur quickly, a command is given and the following description applies. When a quick increase in control pressure is desired, the input signal to the solenoid portion 10 is changed from an existing level to a higher level representing the desired control pressure. The solenoid button load increases, pushing the spool 61 against the bias of the spring 68 (or the spool 61 or solenoid armature 12 reach their respective maximum design stroke), this opens a large communication between the opposing surfaces 66 and 57 as well as between the supply port 33 and the control port 34 across the check seat allowing flow and pressure to be transmitted quickly to the control port 34. As the pressure approaches the desired level, the increase in spool load plus the bias of the spring 68 moves the spool leftwardly against the surface 42 on the button 39 closing down the opening between the opposing surfaces 66 and 57 until the desired pressure is reached, at which time the solenoid load, the spool load and the bias of the spring are in balance as described above.

When a quick reduction in control pressure is required, the input signal to the solenoid 10 is reduced to the desired level, thereby reducing the load on the button 39 and the spool 61. The pressure load in the control port 34 plus the bias of the spring 68 push the spool leftwardly to bring the surfaces 66 and 57 closer together and eventually into engagement shutting off communication between the supply port 33 and the control port 34. The control pressure load, pushing on the button 42 adjacent the surface 67 of the spool 61 pushes the surface 67 off from the button surface 42 allowing flow and pressure to pass from the control port 34 to the tank port 36 very quickly. As the pressure in the control port decreases to the desired level, the surface 67 of the spool 61 moves back to the button 39 moving the spool 61 to the left thereby closing communication between the surfaces 66 and 57 and, consequently, closing communication between the supply port 33 and the control port 34 if necessary until the proper pressure balance is obtained as described above.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. A pilot valve having a reciprocal member, comprising:
a housing, said housing including a liquid control valve having an elongate passageway, a liquid supply port adapted to receive a supply of said liquid thereto from a supply and connected to the passageway, a control port connected to the passageway and adapted for connection to a load and a tank port adapted for communication to said supply;
a sleeve positioned in said passageway and sealingly connected to a wall surface of said passageway, said sleeve having a central hole therethrough and a first undercut region in an exterior surface thereof, said first undercut region including a further passageway providing communication from said first undercut region to said central hole;
a spool sealingly, slidingly reciprocally mounted in said further passageway for movement between first and second positions, said spool having a length greater than a length of said sleeve and a central bore therethrough and a second undercut region in an exterior surface thereof communicating with said further passageway, a first end of said spool and said second undercut region having a radially outwardly extending flange larger in diameter than a diameter of said central bore;
an elastically yieldable member for continually urging said radially outwardly extending flange and said spool toward a first position thereof in engagement with a first end of said sleeve to effect a closing off of the communication between said second undercut region and said passageway; and
a second end of said spool having an end surface encircling said central bore to define a nozzle orifice and opposing a parallel surface on an end of said reciprocal member configured to selectively move toward and away from said nozzle orifice to control a level of pressure at said control port.

2. The pilot valve according to claim 1, wherein said sleeve is forced fit into said passageway to a location whereat only said supply port communicates with said first undercut region.

3. A solenoid operated, three way, normally closed, high flow, pressure compensated proportional pilot valve, comprising:
a housing, said housing including a liquid control valve having an elongate passageway, a liquid supply port adapted to receive a supply of said liquid thereto from a supply and connected to said passageway, a control port connected to said passageway and adapted for connection to a load and a tank port connected to said passageway and adapted for communication to said supply;
an annular coil of electrical wire mounted in said housing and having a central hole therethrough;
a first magnetic pole piece oriented adjacent a first axial end face of said annular coil and a second magnetic pole piece oriented adjacent a second end face of said annular coil, said first and said second pole pieces being coupled together by a third magnetic piece;
a first hole through said first pole piece coaxial with said central hole;
a second hole through said second pole piece coaxial with said central hole;
an armature of magnetic material rectilinearly movably displaceably mounted in said central hole with sufficient radial clearance therebetween and having non-magnetic rod parts projecting coaxially from axially facing ends thereof, a first one of said non-magnetic rod parts being coaxially received in said first hole with sufficient radial clearance therebetween, an end of said armature remote from said first rod part being coaxially received in said central hole with sufficient radial clearance therebetween and to define a non-working air gap;
first and second substantially linear spring for securing respective said first and second rod parts to said housing to effect a frictionless resilient suspension of said armature in said central hole and to orient an annular axial end face of said armature adjacent said first rod part in opposing relation to said first pole piece to define a working air gap therebetween;
a sleeve positioned in said passageway and sealingly connected to a wall surface of said passageway, said sleeve having a central hole therethrough and a first undercut region in an exterior surface thereof, said first undercut region including a further passageway providing communication from said first undercut region to said central hole;
a spool sealingly, slidingly reciprocally mounted in said further passageway for movement between first and second positions, said spool having a length greater than a length of said sleeve and a central bore therethrough and a second undercut region in an exterior surface thereof communicating with said further passageway, a first end of said spool and said second undercut region having a radially outwardly extending flange larger in diameter than a diameter of said central bore;
an elastically yieldable member for continually urging said radially outwardly extending flange and said spool toward a first position thereof in engagement with a first end of said sleeve to effect a closing off of the communication between said second undercut region and said passageway; and
a second end of said spool having an end surface encircling said central bore to define a nozzle orifice and opposing a parallel surface on an end of said first one of said non-magnetic rod parts configured to selectively move toward and away from said nozzle orifice to control a level of pressure at said control port.
